(19) United States
(12) Patent Application Publication
(10) Pub. No.: US 2021/0176834 A1
(43) Pub. Date: Jun. 10, 2021

(54) Method and System for Preparing Dishes

(71) Applicant: MCHEF GMBH & CO. KG, Bielefeld (DE)

(72) Inventor: Martin EILERTS, Lohne (DE)

(21) Appl. No.: 16/975,311

(22) PCT Filed: Feb. 13, 2019
(86) PCT No.: PCT/EP2019/000038

§ 371 Date: Aug. 24, 2020

(30) Foreign Application Priority Data
Feb. 27, 2018 (DE) 10 2018 001 509.3

(51) Int. Cl. H05B 6/68; F24C 7/08; H05B 6/64; H05B 6/66; A23L 5/10

(52) U.S. Cl. CPC H05B 6/687; F24C 7/08; F24C 7/082; F24C 7/087; A23V 2002/00; H05B 6/668; H05B 6/686; A23L 5/15; H05B 6/6447

(57) ABSTRACT

The invention relates to a method and system for preparing dishes, comprising a cooking appliance, wherein an operating program is started and a supply of available dishes is advised by means of a device. At least one dish is selected and at least one selected dish is placed in the cooking appliance and data relating to the selected dishes is transferred to the control element of the cooking appliance and a preparation program is carried out.

### CROSS-REFERENCE TO RELATED APPLICATIONS AND PRIORITY

This patent application claims priority from PCT Patent Application No. PCT/EP2019/000038 filed Feb. 13, 2019, which claims priority from German Patent Application No. DE 102018001509.3 filed Feb. 27, 2018. Each of these patent applications are herein incorporated by reference in their entirety.

### OBJECT OF THE INVENTION

The present invention relates to a method and a system for preparing at least one dish using a cooking appliance.

### BACKGROUND OF THE INVENTION

Different methods for preparing dishes and different systems for carrying out the method have become known in the state of the art.

Preparing must be understood hereinafter as cooking, roasting, thawing, heating, regenerating or similar methods to render the dishes suitable for consumption.

The objective of the present invention is to provide an advantageous and simple method and an advantageous and simple system whereby the preparation of at least one dish is possible in a simple manner.

This objective is achieved by means of a method with the features of claim 1 and by means of a system with the features of claim 18. Preferred improvements of the invention are the object of the dependent claims. Further advantages and features of the invention are obtained from the general description and the description of an embodiment.

A method according to the invention serves to prepare at least one dish using at least one cooking appliance. The method according to the invention comprises the following steps:
starting an operating program in an operating device;
presenting an amount of available dishes in a supply by means of a device;
selecting the at least one dish from the amount of available dishes;
placing the at least one selected dish in the at least one cooking appliance;
associating at least one preparation program with the at least one selected dish by means of the operating device;
carrying out the at least one preparation program in the at least one cooking appliance.

The method according to the invention has many advantages. It allows an easy and simple operation and the preparation of a dish or also several dishes, and particularly, of parts of high quality and of the highest quality of a menu course as well.

In a preferred improvement, the operating program is run in a removable or external operating device. In simple cases, the operating program may also be started in the cooking appliance itself. Nevertheless, the operating program is preferably run in an independent operating device, and particularly in a computer. In a particularly preferable manner, a mobile computer such as a smart phone or a tablet, or a laptop is used for executing the operating program. The operating program can be configured as an “app” and basically be installed in any smart phone or also in any PC. Nevertheless, it is also possible for the operating device to be configured as a device part which is removably and wirelessly connected or connectable to the cooking appliance.

In preferred improvements, the amount of available dishes is dispensed by means of an optical and/or acoustic device. More preferably, the device is part of the operating device. Preferably, the amount of available dishes is displayed in a display of the operating device. It is also possible for the available dishes to be dispensed acoustically. For example, a voice output indicating the names and/or code numbers for the available dishes may also take place, such that the user does not have to look at the screen while the amount of available dishes is notified, but rather may do something else while listening. Evidently, inputs in the operating program may also be made in a voice-controlled manner.

The device is preferably part of the operating device. Nevertheless, it is also possible for any internal or external display to be used, to which information may be transferred from the operating device in a wired or wireless manner.

Preferably, data relating to the amount of dishes of the supply, which is accessible by the operating program, is stored in a first data memory. This data memory may be part of the device or of the operating device.

Preferably, data relating to dishes in the first data memory can be identified and/or read into it. For example, data relating to dishes can be scanned by means of a barcode or an OR code on the dishes or their outer packaging. It is also possible for an RFID placed on the outer packaging of the dishes to be detected. Manual input of data relating to dishes is also possible.

In all the configurations, preparation methods suitable for the selected dishes are preferably proposed by means of the operating program. If more than one preparation method is proposed for a selected dish, the user may select from the different preparation methods. Particularly, the preparation program can be modifiable in terms of its parameters such as, for example, the preparation intensity and/or the cooking point. Such a change of the preparation method can then be carried out with the operating program.

It is then advantageous if the operating program associates at least one preparation method with at least one preparation program which is carried out in the at least one cooking appliance. Particularly, at least two preparation methods for at least two selected dishes may be associated with a single preparation program. In this regard, selected dishes can be grouped together and then be prepared at the same time at least partially with the same preparation program in a single cooking appliance. Alternatively, the preparation program and/or the cooking appliance can be adapted in such a way that two different dishes can be prepared together in a cooking appliance by means of a supply of energy placed in a targeted manner. It may be envisaged for the selected dishes to be placed at different times in the cooking appliance, such that energy is applied to one dish for less time and to the other dish for a longer time. The preparation program may then contain an indication generated by means of the operating program as to when a certain selected dish should be placed in the cooking appliance.

The preparation is usually started by the operating program. By means of the implementation of a corresponding instruction or by means of operating a corresponding button, the operating program directly or indirectly sends a corresponding message or a corresponding control instruction wirelessly (or also by cable) to the cooking appliance, whereby a preparation program is activated and then carried out therein, particularly in an automatic manner. In this regard, the changes performed with the operating program in the parameters of the preparation method are transferred as a preparation program to the cooking appliance, such that the preparation runs as desired. It is possible for the entire preparation program to be transmitted from the operating program to a control device in the cooking appliance. Nevertheless, the preparation programs or parts of the preparation programs are preferably stored in a second external data memory. In this case, external must be particularly understood as a data memory which is physically separated both from the operating device and from the cooking appliance. Preparation programs adapted to a new dish offer can then also be later stored in such a memory.

In this regard, it is possible that (final) changes can once again be performed in the preparation program in the cooking appliance itself before the real preparation program is activated in the cooking appliance. To that end for example, a certain period of time (for example, 1 minute or 3 minutes or 5 minutes) may be available, after the operating device has implemented the instruction. Next, the automatic preparation program can be started. Nevertheless, it is also possible to intervene at any time in the preparation program via the operating device and/or to perform changes in the cooking appliance itself. The changes introduced in the cooking appliance itself are preferably transferred (back) to the operating program in the operating device, and they are displayed and taken into account therein.

In an advantageous manner, a set of cooking appliances with at least two cooking appliances is provided, from which set at least one cooking appliance can be selected. Particularly all the cooking appliances of a set of cooking appliances can then at least be selected when the cooking appliances of the set of cooking appliances are available when queried. Alternatively, the operating program may comprise a user administration whereby individual users are only authorized to select part of the cooking appliances of the set of cooking appliances. A cooking appliance is usually identified as unavailable when the cooking appliance is already associated with a dish when queried, or when a preparation program is already being run and the cooking appliance is therefore unavailable for a further preparation. The cooking appliance is then unavailable for a further preparation until the end of the preparation program and the number of available cooking appliances in the set of cooking appliances is reduced in a corresponding manner. In an advantageous configuration, data relating to the cooking appliances of the set of cooking appliances is stored in a third external data memory. This data memory should also be physically separated from at least the cooking appliances and, where appropriate, also from the operating device. It is essential in any event for the operating device, and particularly the operating program, to have access to the data in the data memory.

Before granting access authorization, authentication may be requested, so the user has to log in with a username and a password before access to the data memory is granted. Unequivocal identification of the respective cooking appliances corresponds particularly to the stored data. Otherwise, preferably data relating to the properties and the capabilities of the respective cooking appliances is stored, such that a cooking appliance suitable for carrying out a preparation program can be selected by means of the operating program.

In all the configurations, the cooking appliances of the set of cooking appliances preferably report their respective operating status to the operating program, and the operating program particularly lists the cooking appliances and preferably displays the operating status thereof. The user thereby obtains in a quick and simple manner information about which cooking appliances are available and what their current operating status is. For example, one of the cooking appliances may carry out a preparation program when queried and may not be available for an additional interval of 10, 20 or 30 minutes. Such information can be listed, such that the user can inform himself of the number of cooking appliances currently available and of those that will be available later or in the near future. It is also possible for the users to reserve cooking appliances, such that the reserved times can likewise be displayed, and coincidences avoided. After the selection of a cooking appliance by means of the operating program or while carrying out a preparation program, it is also interesting for the user to know the operating status of the cooking appliances, for example, if the user forgot to close the door or to switch it on, etc. In preferred improvements, the operating program obtains, by means of push notifications, information about the current operating status of the selected cooking appliance and/or the progress of the preparation program and/or the sensor data detected by the cooking appliance. The operating program then particularly provides the operating status of the selected cooking appliance and the estimated and/or desired end time and the duration of the preparation. If several cooking appliances from a set of cooking appliances with preparation programs having a different cooking duration are selected, it is thereby advantageous if the operating program starts the preparation programs in the different cooking appliances in such a way that all the preparation programs end at least approximately at the same time.

In all the configurations, the cooking appliance preferably comprises at least one heat source. Particularly, the cooking appliance comprises at least one high-frequency heat source. In this regard, at least one wavelength and/or frequency and/or at least one phase of the high-frequency radiation emitted throughout the preparation program can be modified. Particularly, a frequency and/or a wavelength and/or at least one phase of the emitted high-frequency radiation can be modified several times and are modified several times to cook the dishes to be prepared until they are ready or to finish preparing them.

The system according to the invention serves to prepare at least one dish and comprises at least one cooking appliance with a control device and an independent computer which can be connected by means of data connection to the cooking appliance. The computer is set and configured for starting an operating program and presenting a supply or an amount of available dishes in a supply by means of a device. At least one dish can be selected with the computer and data relating to the selected dishes can be transferred to the control element of the cooking device. At least one preparation program can be carried out by the cooking appliance.

Particularly, the system is suitable and is configured for executing individually or in combination with one another one or several of the above-described method steps.

In general, the invention provides an advantageous system and an advantageous method whereby registered users may particularly control an operating device. Preferably, a user registers or logs in by means of the operating device and access to the available data may then be granted.

The data available in a data memory particularly includes dishes which, for example, are kept in a refrigerator and/or a storeroom and are envisaged for preparation, i.e., they have been identified in the data memory but have not yet been prepared. It is possible to navigate through different menu items with the operating program. A dish and a type of preparation can be selected from a supply or from the amount of available dishes.

It is likewise possible to select a cooking appliance from a set of cooking appliances which must be used to perform the preparation. Upon selecting the cooking appliance, it is preferably verified if the desired cooking appliance is available at the desired time or if it is otherwise occupied or needed during the planned time of use.

There may be stored an authorization concept whereby individual users may only access certain dishes, certain types of preparation, or certain cooking appliances.

After selecting a cooking appliance, the appliance status of the corresponding cooking appliance is modified, such that no other user may reserve or use the cooking appliance (in the relevant period of time) anymore.

The individual dishes of a menu can be combined with one another. In this regard, it is possible for the operating program to offer autonomous proposals as to which dishes can be reasonably combined with one another. Dishes having a shelf-life that is set to expire within a predetermined or predeterminable period may also be proposed. Individual meals or complete menus can be selected for preparation.

In a preparation list, the selected meals are clearly displayed before the user is prompted to place the selected dishes in the selected cooking appliances. For the individual dishes of the preparation list, changes to the preparation program can be made to adjust the cooking point, for example.

After the selection and confirmation, the preparation program is then carried out. The end time is displayed on the user interface of the operating device. Preferably, the times for the individual menu courses are also displayed.

Further advantages and features of the present invention are obtained from the description of the embodiment which is explained below in reference to the attached drawings.

### BRIEF DESCRIPTION OF THE DRAWINGS

FIG. 1 shows a schematic overview of a system according to the invention for preparing dishes;

FIG. 2 shows an interface of the operating program in a specific method step;

FIGS. 3-7 show flowcharts of the control of the system, and

FIG. 8 shows a block diagram of the data processing units of the system according to the invention.

### DETAILED DESCRIPTION OF THE DRAWINGS

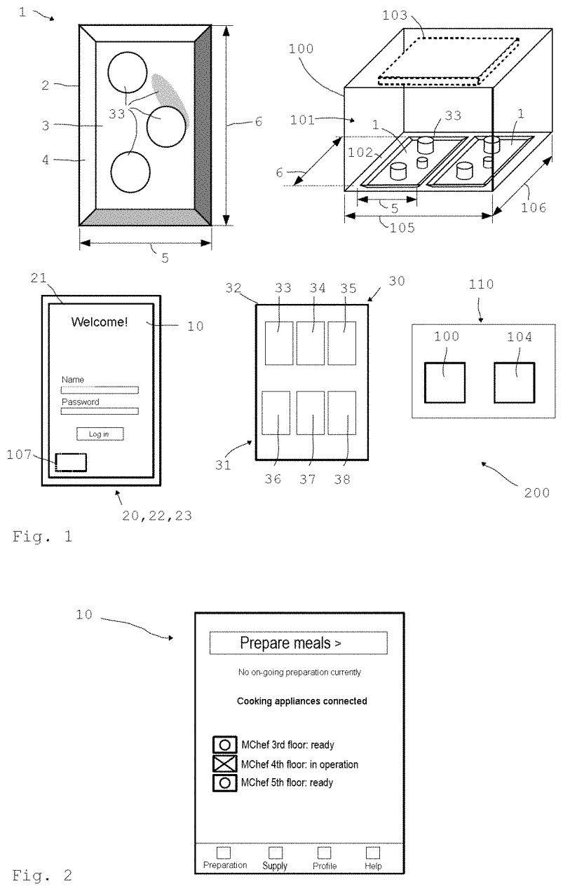

FIG. 1 shows, as a whole, a system 200 with at least one cooking appliance 100 and one, particularly independent, operating device 20 such as, for example, a smart phone. The top left side of FIG. 1 depicts a highly schematic plan view of a tray unit 1 in which dishes 33-38 can be arranged.

The tray unit 1 is configured as a rectangular plate, has a base section 3, and an edge section 4 which, in this case, comprises a total of four edge segments in the longitudinal and transverse borders. The edge section 4 laterally delimits the base section 3. The base section provides enough space for several dishes 31 which can be part of a menu course, for example.

It is possible and preferable for a complete menu course to be placed in the tray unit 1. Of these dishes, at least some can be partially prepared, i.e., at least partially precooked. All the components of a plate may have the same aggregate state, however, the components in different plates may also have different aggregate states. In that sense, for example, a first tray unit may also contain deep-frozen dishes and another tray unit may only contain dishes with refrigerated components.

In the specific embodiment, the tray unit 1 has a tray width of about 10 cm to 25 cm, and in this case, about 17 cm. The tray unit 1 has, in this case, a tray length between about 20 cm and 36 cm, and in this case, about 33 cm. However, other dimensions are also possible. Particularly, the outer dimensions of the tray unit 1 are adapted to the inner dimensions of a cooking level 102 of a cooking space 101 of a cooking appliance 100 which is schematically depicted in the top right side of FIG. 1. In a particularly preferred manner, two tray units 1 can be located at the same time at the cooking level 102 of the cooking appliance 100. Two or preferably four tray units can therefore be housed at the same time (at two cooking levels).

Preferably, the width 105 of the cooking space is about more than twice the width 5 of the tray unit and/or the length 106 of the cooking space is a little longer than the length 6 of a tray unit. The tray units should fill a cooking level 102 of the cooking space 101 as completely as possible, but also still leave a small intermediate space with respect to one another and with respect to the cooking space walls. This therefore makes it easier for the operator to easily remove the individual tray units. It is particularly advantageous for the intermediate space between and around the tray units to be 10% to 40%, and particularly 20% to 40%, of the surface of the cooking level.

The cooking appliance 100 has at least one high-frequency heat source 103, the irradiated frequency and/or phase of which can be changed in a controlled manner during operation. Preferably, at least two antennas (not depicted) irradiate high-frequency energy and the irradiated frequencies of the high-frequency heat sources 103 and the phase differences thereof can be changed depending on the measured scattering parameters.

Specific regions and/or specific parts of the dishes in the tray units 1 can therefore be cooked or regenerated in a targeted manner, whereas other dishes 30 remain almost or completely free from the influence of the high-frequency heat source 103 due to their composition and/or their consistency or their spatial arrangement. By means of housing two or more tray units at the same time, two or more dishes arranged on the tray units can be accordingly prepared at the same time. This is therefore also possible when different dishes are located in the tray units 1. This therefore reduces the number of cooking appliances that are required at the same time when the final preparation of a meal for a group of people must take place at the same time.

It is possible for the cooking appliance 100, in addition to the high-frequency heat source 103, to also have further heat sources, such as those used in conventional cooking appliances.

The lower half of FIG. 1 depicts in a highly schematic manner on the left side an operating interface of an operating program 10 of an operating device 20. After starting the operating program, the first method step depicted in this case shows a welcome screen and the requirement to specify a name and a password to satisfactorily log in. A data memory 107 is depicted with a dotted line, which can be part of the operating device 20 or be accessible by the operating device 20 in a wired or wireless manner.

In the center of the lower part of FIG. 1, a supply 30 is depicted for example as a refrigerator 32, in which an amount 31 of different or identical dishes 33-38 is stored. Data relating to the dishes 33-38 located in the supply 30 is stored in the data memory 107.

A set 110 of cooking appliances is available to perform preparation, two cooking appliances 101, 104 being indicated by way of example in this case, which can be used for preparing dishes 33-38.

FIG. 2 shows the interface of the operating device, and particularly the display area of a smart phone, after the user has logged in on the screen mask depicted in FIG. 1. It shows the depicted interface in which the available and connected cooking appliances are displayed. To that end, the operating program 10 accesses a third external data memory 109 which is preferably in a cloud 120 of a cooking appliance manufacturer or a cooking appliance distributor, see FIG. 8. The cooking appliances 100, 104 can then be registered in this data memory during purchase or installation. Furthermore, additional cooking appliances can also be acquired and registered later and identified accordingly with respect to the operating program. Furthermore, the operating program accesses a second external data memory 108, see also FIG. 8. In this data memory 108 different preparation programs 41 are stored, as scripts which are converted by a program 121 in the cloud 120 into machine-readable programs and then forwarded to the cooking appliances 100, 104.

In the interface of FIG. 2, three cooking appliances (not depicted) can be controlled with the operating program 10, namely a cooking appliance in the third floor, a cooking appliance in the fourth floor, and a cooking appliance in the fifth floor of the operator. Of the three cooking appliances that are displayed, the cooking appliances in the third and fifth floor are ready and available for preparing dishes. In contrast, the cooking appliance in the fourth floor is in operation, such that it cannot be selected at that moment. Evidently, several cooking appliances can also be operated in the same installation site. For example, according to the design configuration, the button for the cooking appliance in the fourth floor can turn grey or another color to indicate that this cooking appliance is not currently available. In this case, four menu items, i.e., “preparation”, “supply”, “profile” and “help”, can be selected in the lower section of the operating interface. A large button with the inscription “prepare meals”, the actuation of which will lead to actual operation, is provided in the uppermost section.

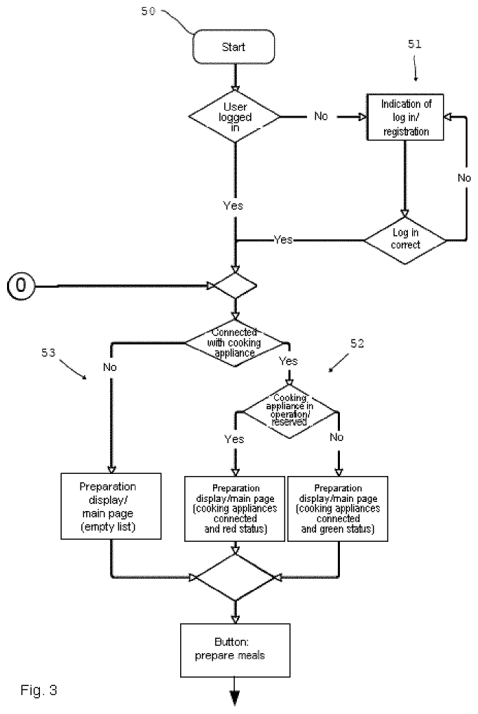

Flowcharts for the operating program, whereby the logic and progression of the operating program 10 can be understood, are reproduced below in FIGS. 3 to 7.

After operating button 50 (start), the user is brought to the log-in, as depicted in FIG. 1. When the user has yet to log in, he is directed to branch 51 of the flowchart, after which the log-in or registration is indicated. The user remains therein in a loop until the log-in has been correctly processed or until the user has been registered. Thereafter, an interface according to FIG. 2 is presented in which the cooking appliances that are connected, i.e., associated with the user, are displayed. Evidently, a set 110 of cooking appliances can also be associated with several users, or only certain appliances 100 of the set of cooking appliances can be associated with individual users, and the others (appliance 104) are, however, not associated. This means that in addition to user administration, the operating program 10 may also comprise an authorization concept for individual appliances 100, 104.

If cooking appliances are connected, the menu navigation follows branch 52 and the user can see which cooking appliances are in operation or reserved. The cooking appliances that are reserved or currently in operation can be displayed with a corresponding status and be presented in red, for example. In contrast, the cooking appliances which are connected and are available at the moment can be provided with a green status notification.

If no cooking appliance is connected, an empty list is displayed, and it can be reported to the user that he or she must first register the cooking appliances in the third external memory 109. For example, this is the case when first setting up the system 200 described further above.

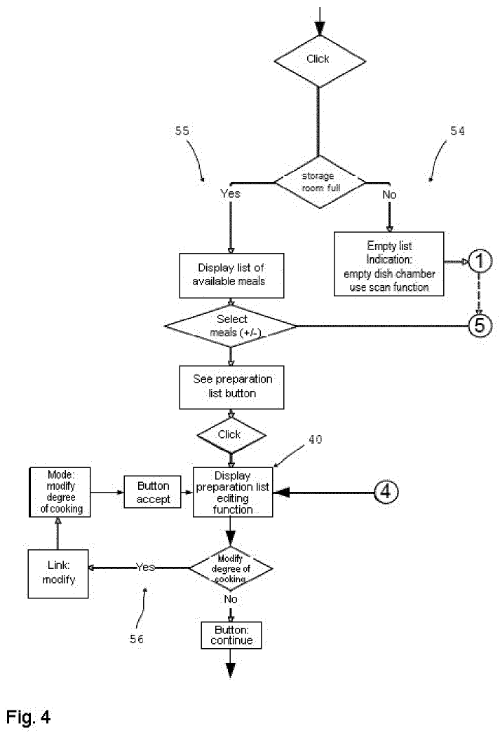

After operating the “prepare meals” button, the flowchart depicted in FIG. 4 is implemented. If the storage room is full (in this context, full means at least one dish 33-38 is registered in the memory 107 of the operating device 22), branch 55 is followed and a list of available meals is displayed in the device 21 of the operating device 20. The user can select one or more meals therein.

In contrast, if the storage room is empty and there will be no more dishes in supply, branch 54 is followed and the indication of the dish storage room being empty is issued. The user is recommended to use the scanning function to add dishes that are still in the supply or to add dishes originating from other sources.

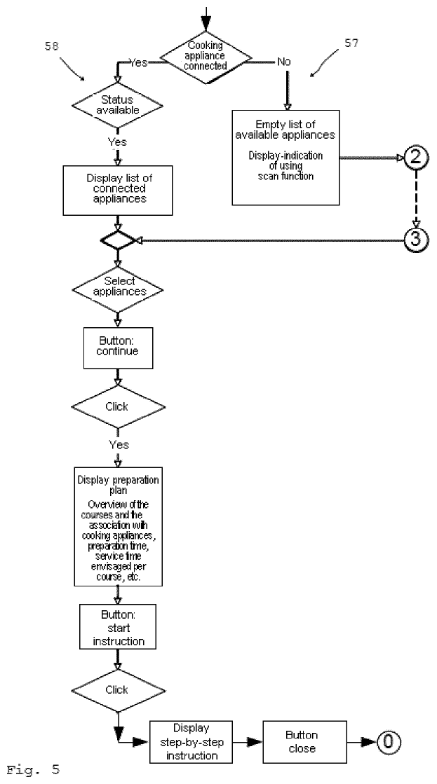

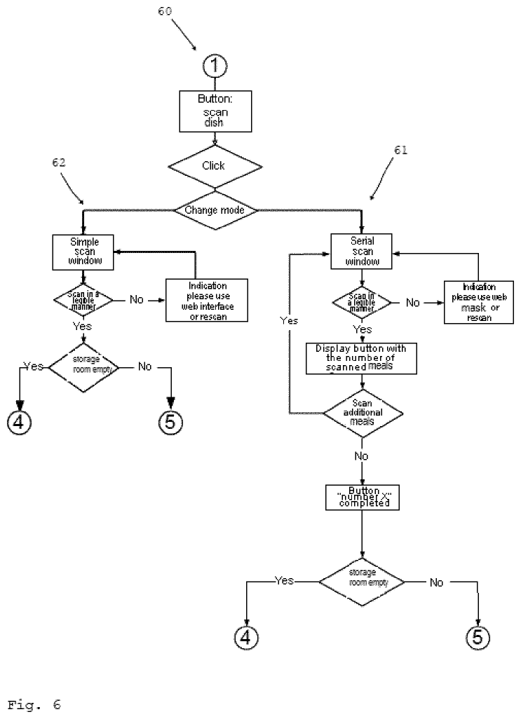

After selecting the meals and displaying a preparation list with the selected dishes 33-38, the current preparation list can be edited. In that sense, it is then possible to choose a preparation method (branch 56) for the single dish, and to thereby modify, for example, as depicted, the degree of cooking (rare/medium/well done) of individual dishes or of all of them. Evidently, other cooking parameters, such as roasting or the like, can also be selected. The user is redirected to the preparation list, step 40, by means of undertaking a modification of the preparation method. The operating program then associates suitable preparation programs 41 with the preparation methods (see FIG. 8). These preparation programs 41 are stored as scripts in a second external data memory 108. Either the same dishes or dishes which can be prepared with the same preparation program are reasonably combined with one another and the user is advised to place these programs in the same cooking appliance. After further operating the button, the user arrives at the flowchart according to FIG. 5, in which the connected cooking appliances are displayed as input.

When the cooking appliances 100, 104 are connected, their availability is displayed, and they are visibly presented in the list of connected cooking appliances. One or more cooking appliances can be selected from the list of available cooking appliances, and a preparation plan containing, particularly, an overview of the courses and the association with the cooking appliances, can be displayed. In this regard, the preparation time of the individual dishes and the expected completion of all the dishes are also preferably presented.

Finally, the preparation process can be started. To that end, the necessary preparation programs are transferred as scripts from the second external data memory to the cloud 120 and transformed into machine-readable data therein by means of a program 121. These are transferred to the respective cooking appliance 100, 104 and stored therein in a volatile memory. The cooking appliances 100, 104 then implement the preparation programs and prepare the dishes 33-38. The preparation programs of the individual cooking appliances can be started with a time delay such that all the cooking appliances complete the preparation programs at least at about the same time. Furthermore, the preparation programs for at least two dishes may require placing the dishes in the cooking appliance with a time delay. For this purpose, a request can be made in the operating program.

If the storage room is empty in the flowchart according to FIG. 4 and branch 54 is followed, the user is directed to the number “1”, whereby a scanning function is activated.

The individual method steps are depicted in FIG. 6. By means of operating a “scan dish” button, the user can select the mode and choose between the simple mode or the serial mode for scanning meals and dishes. Branch 61 is followed when the serial mode is selected, and branch 62 is followed when the simple mode is selected.

If branch 62 is selected, a simple scan window pops up. Particularly, a dish is scanned optically or by means of radiofrequency identification (RFID). If the scan provides a legible result, the corresponding dish from the storage room 30 is added and recorded in the data memory 107. If the scan is not legible, an indication is dispensed, and the user is advised to perform a new identification or asked to enter the data manually.

In the serial selection according to branch 61, several dishes 33-38 are added one after another to the storage room 30. To that end, a loop takes place in which the individual dishes are scanned and data relating to said dishes is added to the data memory 107. One or more dishes can be added to the supply 30 by means of such measures.

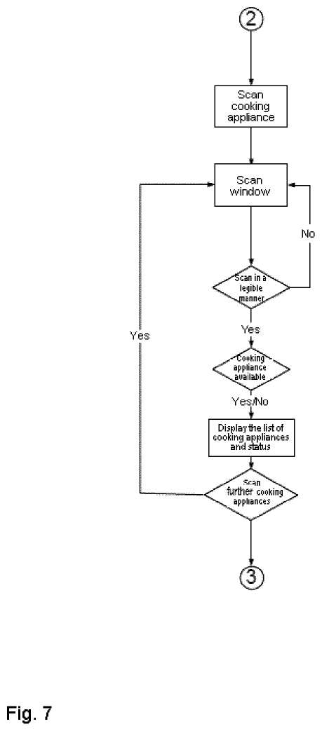

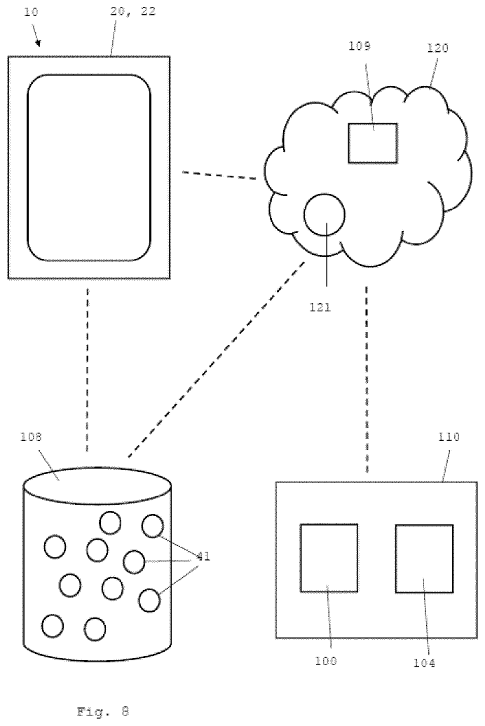

If, in the depiction according to FIG. 5, branch 57 is taken because only one empty list of available cooking appliances is determined, the user is therefore advised to enter the available cooking appliances manually or to use the scanning function to add available cooking appliances. FIG. 7 schematically shows the exact sequence.

After operating “scan cooking appliance”, the scan window opens and a barcode of a cooking appliance is detected, particularly in an optical manner, for example. When the scan is of sufficient quality and legible (and the recognized cooking appliance is currently available), it is added to the display list of the (currently available) cooking appliances. After satisfactorily adding a cooking appliance, additional cooking appliances can be scanned and added. If the scan is not satisfactory, scanning must be repeated, or the corresponding data must be entered manually.

The invention provides, as a whole, a method and a system whereby the dishes of a supply and cooking appliances available for preparing the dishes can be accessed directly after starting an operating program, or after logging in, and/or after a successful registration. There may be present in a main window different menu items which, for example, lead to the preparation or lead to the supply, or the refrigerator, or to data thereof, so as to browse in a selection of available dishes, for example. It is possible for the operating status of all the available cooking appliances to be displayed in the main window or the main view of the operating program.

If a preparation is already active in a cooking appliance, it is displayed particularly on the main page and the home page or the like. In particular, this also takes place when, after starting a preparation program, the operating program was closed again and is restarted. The on-going preparation programs are then preferably displayed directly (after logging in). Preferably, editing or changing and adapting a preparation program is no longer possible during on-going operation.

During display of the individual dishes and/or cooking appliances, it is possible to call up auxiliary functions dispensing further information relating to the use of the operating program and/or the type and the nature of the dishes in the supply.

By clicking on a corresponding icon of a corresponding dish, the dish is added to the preparation list. Preferably, whether or not further dishes can be added is then displayed. If necessary, the amounts can be corrected. It is possible to select individual meals or complete menus for preparation thereof. It is also possible for the operating program to generate complete menu proposals based on the dishes in the supply.

It is preferable to present a view in which a detail page with data relating to the selected dishes is displayed.

If, for example, a meal which is per se not contained in the supply and is provided, for example, by a third party, is to be prepared, it is possible and preferable, for example, to scan a QR code on the outer packaging of the dishes with the camera function of a smart phone so as to record the dish in the (data) supply. Several dishes can thereby be added to a preparation process.

Before the actual preparation program starts, a preparation list preferably clearly shows the selected meals. If necessary, in this case, the amount can still be adjusted, and individual dishes can still be removed or added. Indications of the best before date can be displayed. In the case of dishes with an adaptable cooking point such as, for example, a sirloin steak, the possibility of defining the cooking point is preferably offered.

After selecting the dishes to be prepared, the cooking appliance or appliances in which the preparation must take place is/are selected. If there is only one cooking appliance available, this step is omitted. As a general rule, all the available cooking appliances are displayed, and the user can choose the cooking appliance in which the preparation must take place.

The operating program preferably computes, based on the chosen dishes and on the available cooking appliances, a corresponding menu order, and accordingly which dishes can and must be prepared at the same time in which cooking appliances. Furthermore, the time required by the individual preparation steps and the time at which it can be expected for the individual dishes to be completed.

Manual adaptation of the preparation plan is possible and preferable.

When everything is defined as desired, preparation can be started at any time or with a time delay.

After the start, data relating to the dishes or the preparation methods selected for the dishes is associated with preparation programs and they are distributed to the cooking appliances and executed in said appliances. During execution, data relating to the current operating status of the cooking appliances and the progress of the started preparation programs, if necessary, even sensor data detected by the cooking appliance, are read out by the cooking appliances via the cloud and the second external data memory and sent as push notifications to the operating program. The user thereby obtains information about the completion (and, if he or she so desires, also about the progress) of the preparation, such that the user can perform other activities during the preparation or cooking operation. Furthermore, the user is informed of anomalies that may occur in the progression of the preparation. The operating program showed the user step-by-step what to do, when, and in what order.

1. A method for preparing at least one dish using at least one cooking appliance, comprising the following steps:
starting an operating program in an operating device;
presenting an amount of available dishes in a supply with a display device;
selecting the at least one dish from the amount of available dishes;
placing the at least one selected dish in the at least one cooking appliance;
associating at least one preparation program with the at least one selected dish with the operating device;
carrying out the at least one preparation program in the at least one cooking appliance.

2. The method according to claim 1, wherein the operating program runs in a removable or external operating device.

3. The method according to claim 2, wherein the operating program is executed in a computer and particularly a mobile computer such as a smart phone, a tablet, or a laptop.

4. The method according to claim 1, wherein the display device presenting the amount of available dishes is an optical and/or acoustic device.

5. The method according to claim 4, wherein the display device is part of the operating device.

6. The method according to claim 1, wherein data relating to the amount of dishes of the supply, which is accessible by the operating program, is stored in a first data memory.

7. The method according to claim 6, wherein data relating to the dishes can be identified and/or added.

8. The method according to claim 1, wherein preparation methods suitable for the selected dishes are proposed by means of the operating program.

9. The method according to claim 8, wherein at least one preparation method can be modified in terms of parameters such as, for example, the preparation intensity and/or the cooking point.

10. The method according to claim 8, wherein the operating program associates at least one preparation method with at least one preparation program which is carried out in the at least one cooking appliance.

11. The method according to claim 10, wherein at least two preparation methods for at least two selected dishes are associated with a preparation program.

12. The method according to claim 11, wherein the preparation programs or parts of the preparation programs are stored in a second external data memory.

13. The method according to claim 1, wherein there is provided a set of cooking appliances with at least two cooking appliances, of which at least one cooking appliance can be selected by means of the operating program.

14. The method according to claim 13, wherein data relating to the cooking appliances of the set of cooking appliances is stored in a third external data memory.

15. The method according to claim 13, wherein the cooking appliances of the set of cooking appliances report their respective operating status to the operating program and the operating program lists the cooking appliances and displays their operating status.

16. The method according to claim 1, wherein the operating program obtains, by means of push notifications, information about the current operating status of the selected cooking appliance, and/or the progress of the preparation program, and/or sensor data detected by the cooking appliance.

17. The method according to claim 1, wherein at least one cooking appliance has at least one high-frequency heat source, wherein at least one wavelength and/or at least one phase of the emitted high-frequency radiation is modified several times throughout the preparation program.

18. A system for preparing at least one dish, comprising at least one cooking appliance with a control device and comprising an independent computer which can be connected by a data connection to the cooking appliance, wherein the computer is set and configured for starting an operating program and presenting a supply of available dishes by a display device, and wherein at least one dish can be selected with the computer, and wherein data relating to the selected dishes can be transferred to the control element of the cooking device and the cooking appliance can carry out a preparation program.
